(19) United States
(12) Patent Application Publication
(10) Pub. No.: US 2022/0338443 A1
(43) Pub. Date: Oct. 27, 2022

(54) FEED TIMER AND CONTROL SYSTEM

(71) Applicant: Feedtime LLC, Austin, TX (US)

(72) Inventor: Russell W. White, Austin, TX (US)

(21) Appl. No.: 17/719,511

(22) Filed: Apr. 13, 2022

Related U.S. Application Data
(60) Provisional application No. 63/177,459, filed on Apr. 21, 2021.

(51) Int. Cl. A01K 5/02

(52) U.S. Cl. CPC A01K 5/0291

(57) ABSTRACT

A feed timer and control system and method are disclosed. In practice, a feed and control system might include a memory that maintains a feeding schedule, which may include a first feed setting with a start time that is related to a sunrise time for a given location and a feeding duration time. The system may also include a switch that is configured to close a connection between a power source and a motor at the start time. In practice, the switch may remain closed for an amount of time that is the same or nearly the same as the feeding duration time. The memory and the switch may be located within an enclose at least partially defined by a housing component of the system. In operation, the switch may be electrically connected to the motor and the power source even though the motor and the power source may be located outside the enclosure at least partially defined by the housing component.

### CROSS-REFERENCE TO RELATED APPLICATION

This application claims the benefit of U.S. Provisional Application No. 63/177,459, filed on Apr. 21, 2021, in the name of Russel W. White entitled “FEED TIMER AND CONTROL SYSTEM.”

### TECHNICAL FIELD

The following disclosure relates to timer systems, and more particularly to a feed timer and control system.

### BACKGROUND

Throughout history, people have interacted with various types of animals. Whether domesticated livestock, household pets, or even wild animals, people have often needed to periodically feed the animals. Historically, these feeding procedures were manual operations. A farmer, home owner, or other individual would store feed somewhere safe and dry and periodically provide the feed to animals as needed. In some circumstances, the person might be the primary provider of food for the animal. In other circumstances, the feeding could be more supplementary in nature. Whatever the circumstance, the feeding process could become time consuming and physically demanding.

### BRIEF DESCRIPTION OF THE DRAWINGS

FIG. 1 illustrates a feeding system that incorporates teachings of the present disclosure;

FIG. 2 illustrates feed control devices that incorporate teachings of the present disclosure;

FIG. 3 illustrates an example feeding system incorporating teachings of the present disclosure; and

FIG. 4 illustrates a programming procedure incorporating teachings of the present disclosure.

### DETAILED DESCRIPTION

While there may be any number of systems and situations in which a user may elect to utilize some of the teachings disclosed herein, the following detailed discussion focuses on a programmable controller that may be utilized to facilitate the routine feeding of animals. In some cases, the animals might be wild animals like deer, feral hogs, wild turkeys, fish, etc. In other cases, the animals could be pet cats, dogs, hamsters, fish, etc. In still other cases, the animals could be farm based livestock like cattle, sheep, chickens, turkeys, fish, etc. The focus of the following description does not limit the applicable scope of the teachings. It is intended to aid the reader in understanding a given application of the teachings.

From a high level, a feed timer and control system and method are disclosed herein. In practice, a feed and control system utilizing teachings of the present disclosure might include a memory that maintains a feeding schedule, which may include a first feed setting. The first feed setting may be a programmed setting and may include a start time that is related to a sunrise time for a given location, a sunset time for a given location, or a pre-set time (such as 5:00 pm) that does not change over time as the sunrise and sunset times for the given area change. The first feed setting may also include a feeding duration time. In practice, the system could include several feed settings. For example, a designer may want to allow a user to program two, three, four, five, six, or more feed settings that have different start times. The settings may or may not also have different feeding durations. The system may also include a switch that is configured to close a connection between a power source and a motor at the start time. In practice, the switch may remain closed for an amount of time that is the same or nearly the same as the feeding duration time. For example, a user may set a 10 second feeding duration. In such a circumstance, the switch may remain closed for 8 to 12 seconds.

Depending upon design concerns, the memory and the switch may be located within an enclosure at least partially defined by a housing component of the system. In operation, the switch may be electrically connected to the motor and the power source even though the motor and the power source may be located outside the enclosure that is at least partially defined by the housing component.

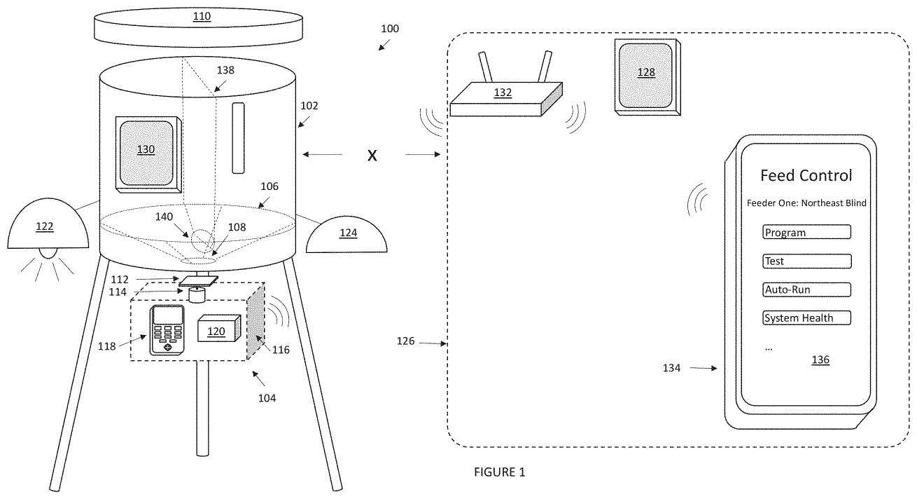

As mentioned above, FIG. 1 illustrates a feeding system 100 that incorporates teachings of the present disclosure. As shown, system 100 includes a feed vessel 102 and a feed dispensing system 104. In practice, feed vessel 102 might be a 55-gallon drum, a metal box, a plastic box, or some other container capable of holding feed. In some embodiments, vessel 102 might include an internal funneling geometry 106 that might help direct feed into a delivery chute 108. Vessel 102 might include a lid 110 and/or sealing mechanism that allows vessel 102 to be at least somewhat water tight in order to protect any feed stored with vessel 102 from rain, snow, wind, and/or other hazards. For example, lid 110 might keep animals from accessing feed stored within vessel 102. Lid 110 or the sealing mechanism may be removable to allow a person to add additional feed to vessel 102 as necessary. The feed stored within vessel 102 might be, for example, corn, a protein pellet, chicken scratch, dog food, cat food, fish food, etc. In some embodiments, vessel 102 may have more than one chamber separated, for example, by a baffle wall 138. As shown, vessel 102 has two chambers separated by baffle wall 138. As shown, at the bottom of baffle wall 138 is chamber gate 140, which may be configured to open and/or close one or more chambers and to allow for a flow of feed or some other stored product onto a casting plate 112. In practice, a user may place corn in one chamber and protein in another. The user may establish a program that feeds corn on occasion, protein on occasion, and/or a combination of corn and protein on occasion.

As shown, dispensing system 104 includes several components. As depicted, dispensing system 104 is a spin casting system that utilizes a casting plate 112 that sits under delivery chute 108. Casting plate 112 may be coupled to a motor 114 that is capable of spinning casting plate 112. Other forms of dispensing techniques may be utilized. For example, a dispensing system incorporating teachings of the present disclosure could make use of a gravity feed system with a controlling gate that may be opened and/or closed to allow and to stop feeding. Other techniques may be used as well.

As shown in FIG. 1, motor 114 is located within a housing box 116. Also within housing box 116 might be a controller 118 and a battery 120. In practice, a power path from battery 120 to motor 114 may be effectively routed through controller 118, which may use a relatively low power signal to open and or close a circuit between battery 120 and motor 114. For example, if controller 118 is programmable and set to feed at 7:00 am for 10 seconds, a circuit between battery 120 and motor 114 may be closed at 7:00 am for a 10 second period and then opened to stop the flow of power to motor 114.

In some embodiments, controller 118 may have several different capabilities and the ability to interface with external devices. For example, controller 118 may be able to turn on and off light 122. In some cases, light 122 may be capable of slowly turning on and/or off. Light 122 may be a red light, a green light, a white light, a light capable of emitting a range of colors, and/or some other variation of light. Controller 120 might also be in communication with motion sensor 124. In practice, a motion signal from sensor 124 indicating movement near system 100 may be stored at controller 118. Controller 118 may simply store the information and/or use it to trigger some other activity such as turning on light 122 and/or closing a power circuit between motor 114 and battery 120 to initiate the casting of feed.

Also depicted in FIG. 1 is a housing 126, which may be for example a hunting blind. Housing 126 may have a solar panel 128 capable of providing power to electronic devices at housing 126. As such, solar panel 128 may have an associated battery. Similarly, vessel 102 may have a solar panel 130 that facilitates, for example, a recharging of battery 120 and/or other batteries associated with components such as controller 118, sensor 124, light 122, etc.

As shown, housing 126 is located some distance “X” from vessel 102 and system 104. In some embodiments, components like controller 118, sensor 124, light 122, etc. may be capable of wireless communication using communication techniques like those described by Wi-Fi (in whatever version or form), Bluetooth (in whatever version or form), UHF, MURS, etc. In some cases, the distance “X” may be great enough to make wireless communication difficult, unreliable, suboptimal, etc. As such, a designer may choose to utilize a booster 132 to facilitate effective wireless communication between devices. As depicted, a smartphone 134 located within housing 126 may be capable of wireless communication. A person trying to use smartphone 134 to communicate with, for example, controller 118 may benefit from a device capable of effectively extending the range of wireless communication such as booster 132. As shown, smartphone 134 may be executing a local application capable of presenting a user interface 136 on a screen of smartphone 134. In practice, the application may be one that is downloadable over the air from an application store.

As shown, the application interface includes selectable buttons with the words “PROGRAM”, “TEST”, AUTO-RUN″, and “SYSTEM HEALTH.” The Application is called “Feed Control” and the combination of vessel 102 and system 104 are labeled as “Feeder One” Northeast Blind. A designer may choose to allow a user to do all kinds of things with the application. For example, a user may select the Program button and have the opportunity to set when feed is dispersed and for how long. The user may be able to assign one or more names to a given feeding system. The user may be able to remotely choose to spin the casting plate to initiate a feeding at a time that is not currently programmed. The user may be able to cause light 122 to begin illuminating the area. The user may be able to check the health of a system (e.g., are batteries charged well; are lightbulbs working; is a motor working; is there feed in the vessel; if there is feed, how much feed; has there been motion near the feeder and when, etc.)

The application may also communicate with a remote computing device to let the device know how a system like system 100 is functioning. The communication may occur, for example, over a wide area wireless network. The communication may be initiated by a user. It may also occur automatically. Communicated information could include system health information, photographic information, motion sensing information, feed usage information, etc. In some cases, a feed provider may utilize the information to know when to deliver feed to a given user and/or system.

In some embodiments, the system may include a speaker and a user may want the speaker to emit sounds that might attract predators like coyotes, fox, bobcats, etc. In such a system, the app executing at smartphone 134 may allow the user to connect with the speaker and to cause the speaker to emit the attracting sound, which could be for example, the sound of an animal in distress.

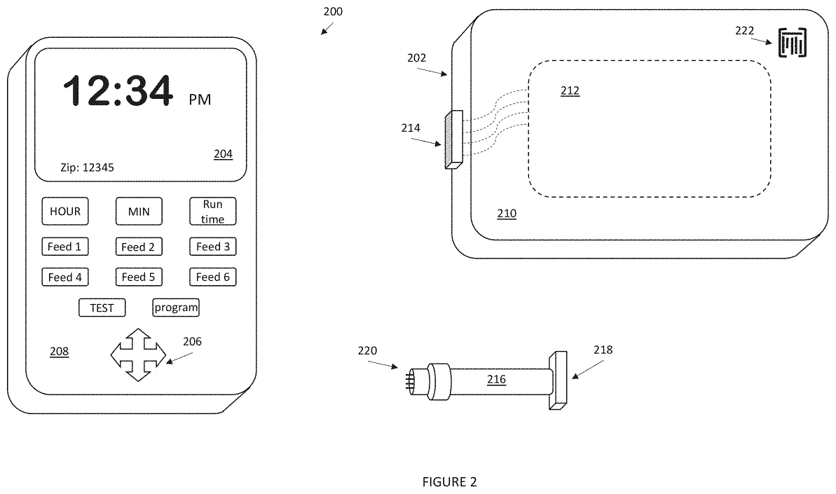

As mentioned above, FIG. 2 illustrates feed control devices 200 and 202 that incorporate teachings of the present disclosure. As shown, control device 200 is a device that has its own screen 204, which may be for example an LCD screen. As depicted, screen 204 is showing a current time “12:34 pm” and a current zip code “12345” for device 200. Device 200 also has several buttons (in the depicted embodiment, there are eleven) and a multi-directional arrow key 206. As shown, the buttons, screen, etc. appear on housing surface 208. Housing surface 208 at least partially forms a housing for device 200 that at least partially defines an internal enclosed portion of device 200 where various components that facilitate the operation of device 200 may be located. These components may include, for example, memory, control circuitry, switches, interfaces, chips, resistors, etc.

In operation, a user of device 200 may program the current time, set various feeding times, set various feeding durations, set a current location of device 200 (which may be done, for example, by indicating the zip code within which device 200 is located), etc. Device 200 may also include a physical interface that effectively allows device 200 to sit between a battery like battery 120 and a motor like motor 114. In effect, a switch within device 200 may turn the motor on and off by allowing power to flow to the motor and stopping the flow of power to the motor.

Also depicted in FIG. 2 is device 202. As shown, device 202 does not have an LCD screen or physical buttons like those shown on device 200. In practice, device 202 does have a housing surface 210. Housing surface 210 at least partially forms a housing for device 202 that at least partially defines an internal portion of device 202 where various components that facilitate the operation of device 202 may be located. These components may include, for example, memory, control circuitry, switches, interfaces, chips, resistors, etc. At least some of these components are represented by board 212, which is communicatively coupled to interface 214. Depending upon design concerns, a designer may choose to seal device 202 to assist in protecting the internal components of device 202. The sealing could, for example, render device 202 effectively weather proof.

In some embodiments, device 202 may have a wireless communication capability and may be programmable using a smartphone executing an application. Depending on designer preferences, device 202 may be offered without buttons or a screen and may be specifically designed for remote programming using a secondary device. In some cases, a person may wish to replace a device like device 200 with a device like device 202. The two devices may have slightly different physical interfaces. As such, a coupling component like interconnect 216 may be utilized. As depicted, interconnect 216 has a first interface 218 configured to connect with interface 214 and a second interface 220 configured to connect with an existing interface that has a different size, shape, pin configuration, etc. In practice, a user of a smartphone executing a controller application may communicatively couple with device 202 using, for example, a Bluetooth transceiver, a Wi-Fi transceiver, a MURS band transceiver, etc. In some embodiments, a designer may elect to use wide area wireless technologies such as cellular technologies, 5G technologies, etc. to communicatively couple various components of systems incorporating teachings of the present disclosure. In connection with the coupling procedure, the smartphone may communicate, date, time, location, and/or other information to device 202. For example, an application may be designed to communicate date, time, location, a calendar of sunrise times, and a calendar of sunset times to device 202, which may store that information in an internal memory. The smartphone may also facilitate a programming of device 202. For example, an application user interface may allow a user to set multiple feeding times and feeding durations for device 202.

As depicted, device 202 includes a scannable identifier 222. In practice, a smartphone camera may be capable of “scanning” identifier 222. This process may initiate the accessing of a remotely stored instance of an application and/or a launching of a local application and provide the application with communicative coupling information for device 202. Identifier 222 may also include additional information about device 202. In some embodiments, the process of communicatively coupling a smartphone to a device like device 202 may include some basic programming steps. For example, the process may establish a location, a date, and a time setting for device 202, which may obviate the need for a user to set those things. Moreover, during an initial connection, an application may prompt the user to name the feeder, initiate a coupling of other components (e.g., a light, a motion sensor, a trail camera, etc.) with device 212, take a picture of the feeder and/or area, etc. This additional information may be stored as information associated with device 202.

In practice, identifier 222 may also facilitate expanding the capabilities of device 202 and/or its network. For example, device 202 may have a Bluetooth transceiver capable of coupling with multiple other Bluetooth transceivers. If a user adds, for example, a lighting component, a motion sensing component, a camera, a remaining feed measuring component, to the system, the act of scanning identifier 222 may facilitate a user's ability to use a smartphone application to add the new component or components and to communicatively couple the components with device 202. Moreover, data associated with and/or created by the additional components may be stored at and/or retrieved from a device like device 202.

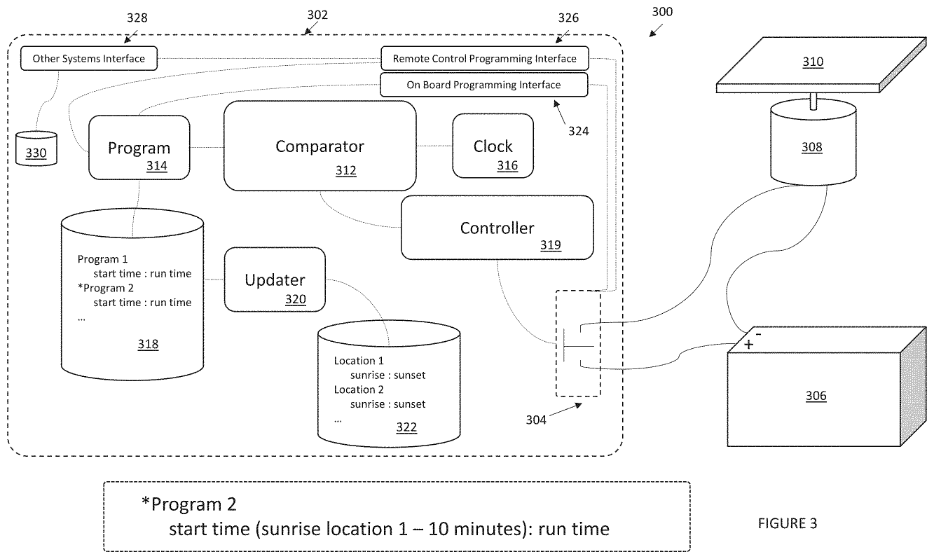

FIG. 3 illustrates an example feeding system 300 incorporating teachings of the present disclosure. As depicted, a controller 302 includes a switching system 304 that sits within a power circuit connecting a power source 306, which may be a 12-volt battery, a 9-volt battery, a solar panel, a solar panel with an associated battery, etc. and a motor 308. As shown, motor 308 is coupled to a casting plate 310. In operation, motor 308 may spin casting plate 310 when switching system 304 is in a closed position. The amount of time switching system 304 remains in a closed position may dictate how long casting plate 310 spins and how much feed is released. A system that also has a feed measuring component may also be able to determine how much (e.g., how many pounds of feed) is released during a given feeding cycle.

As shown, controller 302 may include a board having multiple components and/or logic and memory elements located thereon. A comparator component 312, which may be embodied for example in hardware, software, firmware, etc. is communicatively coupled to a program component 314 and a clock component 316. In operation, clock component 316 may maintain a current time. The current time may be for a geographic location of the controller 302. The current time may include time, date, and/or location information and may be set by a user using some user interface elements associated with controller 302 and/or an application executing on a phone.

Program component 314 may be communicatively coupled to some form of memory 318, which may be storing current programming information. As depicted, memory 318 is storing a “Program 1” having a specific start time and a specific run time and a “Program 2” having a relative start time and a specific run time. As shown, “Program 2” has a start time that is dependent on the sunrise time of the location of controller 302. In practice, a user and/or a smartphone application may have communicated location information and/or sunrise/sunset times to controller 302. The location information could be, for example, a zip code, a latitude and longitude, a closest city, etc. Whatever the location, “Program 2” has scheduled the feeding to begin at 10 minutes before sunrise on the current day.

For some applications, such as hunting applications, a user may want the feeding time to change as the sunrise and sunset times change. “Program 2” represents an example of that type of dependent scheduling. Other dependencies may also be utilized. The feeding time may depend on the detection of motion near the feeder. It may depend on days of the week, etc.

As depicted in FIG. 3, memory 318 is communicatively coupled to an updater component 320, which is communicatively coupled to a memory 322. In practice, memory 322 may include sunrise and sunset date for one or more locations. This information may be used to update programs like “Program 2” which are dependent on current sunrise and sunset times. Memory 322 may be “pre-programmed” with location and date-based data regarding things like sunrise and sunset times. Memory 322 could also be “programmable” and updated when, for example, a smartphone executing an application communicatively couples with controller 302. For example, a smartphone could determine a current location of controller 302, retrieve sunrise and sunset time data for that location, and send the sunrise and sunset times for the actual location of controller 302 for storage in memory 322. In practice, these communications (as well as other communications discussed herein) might happen over a local area wireless network, a wide area wireless network, and/or some other communication network. In some embodiments, controller 302 may be located within a box, like housing box 116. A box like housing box 116 could, in some cases, hinder the transmission of communication signals. As such, an antenna configured to improve the communication range of a controller like controller 302 may be located outside housing box 116 and wired to the controller.

Also included within controller 302 is an on-board programming interface 324 and a remote programming interface 326. These interfaces may facilitate a user's ability to program controller 302. Interface 324 may be coupled with physical buttons and a screen like those depicted on controller 200. Interface 326 may be configured to work with and communicate with an application executing on a smartphone. Also shown with controller 302 is an “Other Systems Interface” 328. In practice, interface 328 may allow controller 302 to communicate with external components which may include, for example, a lighting element, a motion sensing element, a video camera, a still camera, a digital camera, a microphone, a speaker, a weighing component, a component capable of determining how much feed is within a feed hopper, a system health component capable for example of calculating battery health and/or life, etc. Depending upon designer preferences, a memory 330 may be coupled to interface 328 and capable of storing received status or other information for later retrieval by a user, a smartphone application, etc.

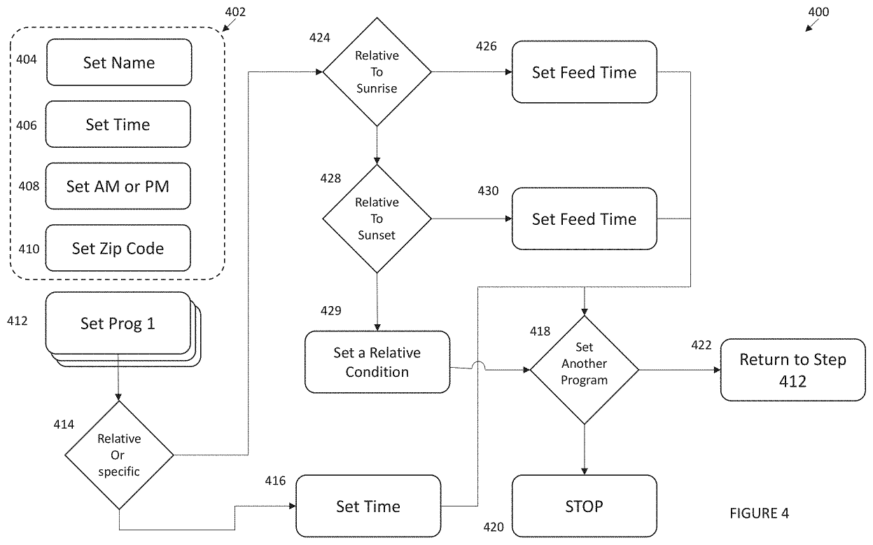

FIG. 4 illustrates a programming procedure 400 incorporating teachings of the present disclosure. As depicted, a number of set up programming items are accounted for in set up procedure 402. Within set up 402, a user may set a name for a given feeder at step 404, set the then-current time for the feeder at step 406, confirm whether the time is AM or PM at step 408, and enter location information for the feeder at step 410. As shown, the location information could be a zip code for the feeder. Other location information could also be used. Moreover, as explained above, several of the set-up steps might be accomplished “behind the scenes” during a hand shake procedure involved in establishing a communication coupling between a feeder control device and an application executing on a smartphone, tablet, computer, etc.

In some embodiments, a programming procedure may advance to a set program phase after an initial set-up phase. As shown, at step 412, a user may elect to begin setting a first feeding program. As shown, the feeding program may have a start time that is specific or relative to some other activity. For example, a feed time may be sunrise and/or sunset time dependent. At step 414, a user may be asked to indicate whether the program will have a relative or specific feed time. If the time will be a specific time, the procedure may advance to step 416, and the user may set a specific feeding time. Step 416 may also allow a user to set a feeding duration. For example, a user may choose to have the feeder run for 10 seconds. Once the specific feeding time program has been set, the procedure may advance to step 418 where a user may be asked if he or she would like to set another program. If the user does not want to set another feeding program, the procedure may advance to a stop at step 420. Depending upon designer concerns, step 420 may be accessible at any point in the procedure. For example, if a user fails to respond to a prompt for some amount of time (e.g., 10 seconds, 20 seconds, 30 seconds, 40 seconds, 50 seconds, 60 seconds, etc.) the procedure may auto-advance to step 420.

If at step 418 a user indicates a desire to continue programming, procedure 400 may advance through step 422 and return to step 412. If at step 414, a user indicates a desire to set a relative feeding time, procedure 400 may advance to 424 where the user is asked if the feed time will be relative to a sunrise time. As indicated above, other dependencies are possible. For example, a user may want the feeding time to be relative to a sensing of motion. If the user wants the feeding time to be relative to a sunrise time, procedure 400 may advance to step 426 where the user may set the feeding duration and establish the relative relationship. For example, the user may select a 20 second feeding duration and choose to have the feeding start 10 minutes before sunrise. Other relative relationships may be possible. The start time may be exactly sunrise. It could be 10 minutes after sunrise. Once step 426 is complete, procedure 400 may advance to step 418 where a user may be asked if he or she would like to set another program. If the user does not want to set another feeding program, the procedure may advance to a stop at step 420. If at step 418 a user indicates a desire to continue programming, procedure 400 may advance through step 422 and return to step 412.

If at step 424 the user indicates that the time will not be relative to sunrise, procedure 400 may advance to step 428. At that point, a user may indicate a desire to set a feed time that is related to the location's sunset time. If the user does not want to do that, the procedure may advance to set another type of relative condition at step 429, and then determine whether continued programming is desired at step 418. If so, control advances through step 422 and returns to step 412. If at step 428 the user wants the feeding time to be relative to a sunset time, procedure 400 may advance to step 430 where the user may set the feeding duration and establish the relative relationship. For example, the user may select a 5 second feeding duration and choose to have the feeding start time begin 5 minutes before sunset. Other relative relationships may be possible. The start time may be exactly sunset. It could be 10 minutes after sunset. Once step 430 is complete, procedure 400 may advance to step 418 where a user may be asked if he or she would like to set another program. If the user does not want to set another feeding program, the procedure may advance to a stop at step 420. If at step 418 a user indicates a desire to continue programming, procedure 400 may advance through step 422 and return to step 412.

To be clear, a designer may choose to create a system that uses all or some of the above teachings in various configurations. The above description teaches several aspects in a complete and yet succinct way. A designer will recognize that he or she can take a teaching, for example, from FIG. 1 and combine it with a teaching from, for example, FIG. 3. A system incorporating teachings of the present disclosure may replace, add, or delete many of the above-described features and components without departing from the scope of the disclosure. One skilled in the art will recognize that many of the above-described components could be combined or broken out into other combinations.

Although the present invention has been described in detail, it should be understood that various changes, substitutions and alterations to the devices, methods, and other aspects and techniques of the present invention can be made without departing from the spirit and scope of the invention as defined by the appended claims.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A feeding system comprising:
a memory maintaining a feeding schedule, the feeding schedule comprising a first feed setting that includes a start time that is relative to a sun related event for a given location and a feeding duration time;
a switch configured to close a connection between a power source and a motor at the start time; and
a housing component at least partially defining an enclosure within which the memory and the switch are located.

2. The system of claim 1, wherein the sun related event is a sunrise time.

3. The system of claim 1, wherein the sun related event is a sunset time.

4. The system of claim 1, further comprising:
a wireless transceiver located within the housing component; and
a programming interface communicatively coupled to the memory, the programming interface configured to facilitate adding a second feed setting.

5. The system of claim 1, further comprising a programming interface communicatively coupled to the memory, the programming interface configured to facilitate modification of the first feed setting.
